(19) United States
(12) Patent Application Publication
(10) Pub. No.: US 2012/0198814 A1
(43) Pub. Date: Aug. 9, 2012

(54) USE OF HOT GASES AND DEVICES

(76) Inventor: Israel Hirshberg, Alfei Menashe (IL)

(21) Appl. No.: 13/502,373

(22) PCT Filed: Oct. 18, 2010
(86) PCT No.: PCT/IL10/00852

§ 371 Date: Apr. 17, 2012

(30) Foreign Application Priority Data
Oct. 18, 2009 (IL) 201610

(51) Int. Cl. F02K 3/06; F02K 9/74

(52) U.S. Cl. 60/204; 60/226.1

(57) ABSTRACT

A method of increasing internal combustion engine efficiency is based on using engine cooling air and exhaust gas by flowing this mixture into a convergent nozzle thus accelerating the gas mixture and eject it through nozzle exit, thus generating thrust in a desired direction which could push a land air or sea vehicle. Another option is to use the accelerated gas to drive a turbine that could add its torque to the engine or to drive electrical generator that produces electricity.

### FIELD OF THE INVENTION

The present invention relates to methods and devices for using residual heat in gases which are by products of burning fossil fuels by accelerating them through convergent nozzle thus converting the internal energy stored in the gases into kinetic energy which is useful for driving turbine to generate electricity or serving as propulsion force.

### BACKGROUND OF THE INVENTION

Internal combustion engines use to power vehicles or stationary systems are known as low efficient energy devices since the internal friction between engine pistons and cylinders is high. This friction is pure waste of thermal energy. Further, burnt air-fuel mixture as exhaust gases are at temperature of about 300° Celsius thus contain considerable amount of energy. Today, these gases are ejected into the atmosphere without being used and as a matter of fact contribute to global warming. Overall efficiency of such engines is about 30-40%. That means the engine output useful work is only 30-40% of the total fuel burning energy.

It is desirable to make good use of heat stored in hot air used to cool engine radiators and heat stored in exhaust gases.

### SUMMARY OF THE INVENTION

According to the present invention, there is provided a method and system to convert heat in exhaust gas or in hot air used to cool radiators into kinetic energy by flowing it into convergent nozzle and using this energy for generating electricity or propulsion.

A major aspect of the present invention is mixing hot gas with atmospheric air and accelerate the mixture by flowing it through convergent nozzle that accelerate the mixture of gases toward nozzle throat where the mixture is either exit as jet which provide thrust to vehicle like aircraft, land vehicle or marine vehicle or driving a turbine that drives electrical generator or provide mechanical moment for any use.

Another aspect of the invention is enclosing a combustion engine for aircraft within a flow of cooling air, and flowing this air through a convergent nozzle so that air is accelerating and ejected as high-speed jet, thus generating jet thrust that pushes the aircraft, this is a piston jet engine.

Yet another aspect of the invention is enclosing an internal combustion engine for aircraft within a flow of cooling air while the engine exhaust gases are mixed with the cooling air, and the gas mixture flows through a convergent nozzle so that the gas mixture accelerated and ejected as high-speed jet, thus generating jet thrust that pushes the aircraft, this is a piston jet engine.

Another aspect of the invention is a piston jet engine having variable exit area to adapt the exit area airspeed to various atmospheric conditions.

Yet another aspect of the invention is using internal combustion engine exhaust gases by flowing them into a stream of atmospheric air and accelerating this gas mixture by flowing it through convergent nozzle, which accelerates the mixture and the gas mixture drives a turbine which drives a electrical generator or provides its mechanical moment to any use.

Still another aspect of the invention is flowing radiator-cooling air into convergent nozzle, which accelerates the air and the accelerated air drives a turbine, which drives a electrical generator or provides its mechanical moment to any use.

Still another aspect of the invention is flowing atmospheric air and radiator-cooling air into convergent nozzle, which accelerates the air mixture that drives a turbine, which drives a electrical generator or provides its mechanical moment to any use.

Yet another aspect of the invention is flowing radiator cooling air toward a convergent nozzle while mixing it with engine exhaust gas, so that the convergent nozzle accelerates the mixture and the gas mixture drives a turbine, which drives a electrical generator or provides its mechanical moment to any use.

Yet another aspect of the invention is flowing atmospheric air and mixing it with radiator cooling air while flowing toward a convergent nozzle and mixing it with engine exhaust gas, so that the convergent nozzle accelerates the mixture and the gas mixture drives a turbine, which drives a electrical generator or provides its mechanical moment to any use.

### BRIEF DESCRIPTION OF THE DRAWINGS

The present invention will be further understood and appreciated from the following detailed description taken in conjunction with the drawings in which:

FIG. 1 is a cross section along top view of a piston engine installed in a pod having inlet and outlet thus this is a piston jet engine according to the invention.

FIG. 2 is a cross section along top view of piston jet engine having variable exit area according to the invention.

FIG. 3 is a cross section along top view of a piston engine installed in a pod having optional one or more axial fans.

FIG. 4 is a cross section of a device, which converts exhaust gas heat into electricity according to the invention.

FIG. 5 is a cross section of a device, which converts radiator cooling air and exhaust gas heat into electricity according to the invention.

FIG. 6 is a cross section of a device, which mixes atmospheric air with radiator cooling air and exhaust gas and converts the heat stored in the gas mixture into electricity according to the invention.

### DETAILED DESCRIPTION OF THE INVENTION

Note: The physics supporting this invention is compressible flow theory as presented in the Reference book: “FOUNDATIONS OF AERODYNAMICS” by A. M. KUETHE and J. D. SCHETZER Department of Aeronautical Engineering, University of Michigan—see P. I in the appendix of this application.

The present invention discloses method and devices, which put into use residual heat in gases, which are byproducts of internal combustion engines operations. A typical internal combustion engine, known also as piston engine, is very popular in driving cars, truck and small aircraft. Piston engines burn fossil fuel. The product of this burning is exhaust gas which is quite hot, about 300° Celsius, thus it contains thermal energy expressed by Enthalpy E:

E=M*C_{P}*T,

Where M is the mass of the gas;

C_{P} is the gas constant pressure specific heat;

T is the gas absolute temperature (Kelvin or Rankine scales)

Usually, this exhaust gas energy is ejected through the exhaust pipe and wasted. The heat ejected by millions of cars and trucks each day is the major contributor to global warming which put serious threat to earth normal weather and oceans' level.

While piston engine burns fuel its pistons are moving fast within their cylinders and generating friction, which heats the cylinders and the entire engine. This heat must be removed from the engine otherwise engine lubricating oil will be heated beyond its maximum allowed temperature and lose its ability to keep friction at low level. When this happens, the engine is overheated and ruined. To prevent lubricating oil from overheating, a cooling system is installed. One such system uses water that flows around the engine, warmed up and flow to a radiator where atmospheric air is forced to flow through this radiator and cools the water within the radiator so this cooled water flow back to cool the engine and so on. The “product” of this cooling system is hot air, which contains thermal energy is discarded into the atmosphere and increase global warming. Overall piston engine efficiency is about 30%, i.e. about 70% of the thermal energy produced by the burning process is more than just a waste! It is a major factor in global warming. This invention discloses an efficient method of utilizing the piston engine wasted heat by converting this wasted energy into useful energy such as electricity or mechanical power, which eventually lower the amount of burnt fuel and lower the amount of heat introduced into the atmosphere. As a byproduct, this invention also creates more economical engines.

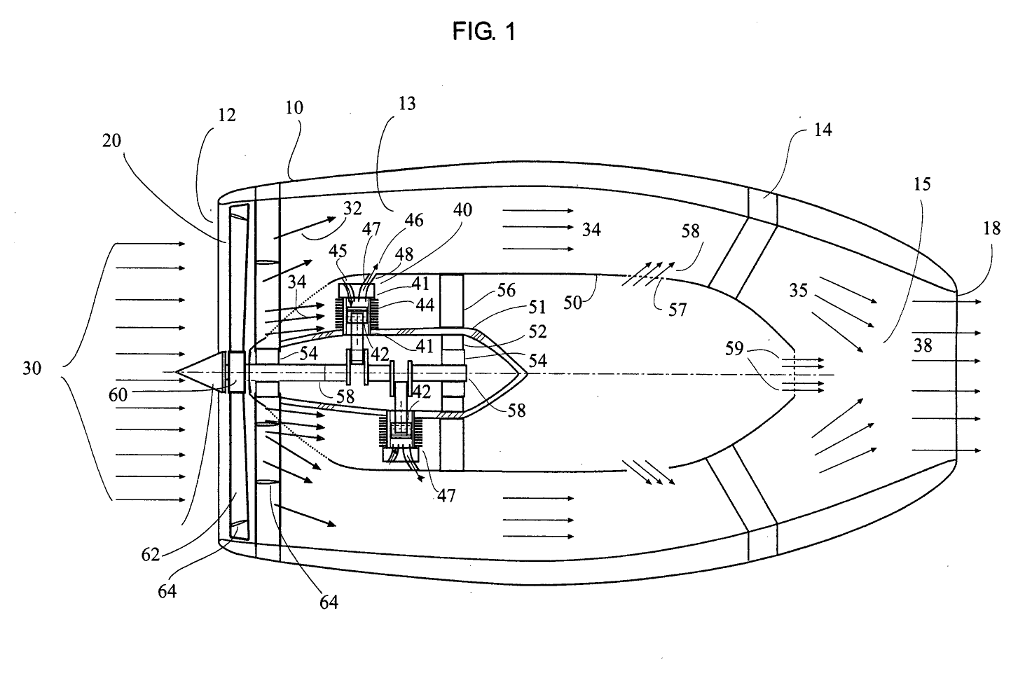

FIG. 1. is a cross section through a pod 10 having inlet 12 and exit 18. A piston engine 40 is installed within this pod nozzle 13 and optionally enclosed by inner pod 50, preferably made of metal skin. The inner pod 50 aimed to reduce the friction between the flow 32 and the engine cylinders 41, 47. The piston engine comprises of two cylinders 41 and 47, however any number of cylinders is possible. The piston engine main shaft 58 (crank shaft), is rotated by the pistons 42.

The engine main shaft 58 drives a fan 20, which comprises of any number of blades 62 from 2 to any desirable number. Fan 20 rotates and sucks atmospheric air 30 into the pod's inlet 12. When the airflow 32,34 passes the fan, its pressure increases and it has certain velocity VI. The outer air flow 32 flows around the engine optional enclosure 50 and absorbs heat from the metal skin 50 which absorbs heat generated by the piston engine. This airflow continues to flow toward the exit 18 as airflow 34, where it mixes with airflow 58 that exit enclosure 50 through opening 57. Airflow 34 flows around the piston engine cylinders 43,47 and absorbs heat from the cylinder cooling ribs 44 then continue to flow and exit the enclosure 50 through opening 57 and optional opening 59. Optionally, burnt fuel exhaust gas 46 exits the cylinder 43 through pipe 48. It should be noted that exhaust gas 46 is very hot and while it meets airflow 32 it rapidly mix with it thus transferring its heat within the distance between opening 48 and opening 57. Therefore the temperature of airflow 34 is higher than the temperature of airflow 30. Airflow 58 temperature is also higher than airflow 30 temperature since it absorb heat from cylinders 43, 47. Finally, the airflow 35 flows into convergent nozzle 15, which according to the continuity law, forces the airflow 35 to accelerate toward the throat 18.
ρvA=constant EQ. 1—see REF book P. 155 EQ. 22—also P. 2 in the appendix of this document, accelerate airflow speed as the cross section of the nozzle 15 decreases.
The continuity law: ρvA=constant
Where: ρ is the gas density;

v is the gas speed; and

A is the flow cross section area—assuming average speed v all over this area.

Note: continuity law stems from mass conservation law. Since the gas mass rate is constant at each cross section and the speed V is increased as the cross sections decrease, that means the gas kinetic energy increases toward the throat 18 where the cross section area has a minimum. The increment of the gas kinetic energy is on the expense of the gas temperature T, according to Bernoulli's law for compressible flow:

C_{P}T+v²/2=constant—EQ. 2—see Ref. Book P. 140 EQ 24—P. 3 in the appendix.

Where: C_{P} is the gas constant pressure specific heat , C_{P}]ₐᵢᵣ=6000 ft-lb/slug ⁰R

T is gas absolute temperature (Rankine)

V is gas speed [FT/SEC]

This equation is for unit mass (in British unit system m=[slug]; in metric unit m=[KGM]. Thus, the ratio between the area cross section at 18 versus the nozzle 15 area at 59 determines the airflow 38 speed, which could be as high as Mach=1 since the fan 20 gives the airflow 32 initial speed of about 100 meter/second and in case the areas ratio is 3, that means airflow 38 has a speed of about 300 meter per second. However, the piston engine add the burnt fuel mass into the flow 30, thus the actual flow 38 speed is increased by a factor which is larger than the inlet 12 area divided by the exit area 18.

Since accelerating gas in a convergent nozzle lowers the gas temperature, according to Bernoulli's law for incompressible flow, the heat from the piston engine (exhaust flow 46 and cooling flow 58, 59) contribute significantly to the airflow 38 temperature and this increases the speed of sound (Mach=1) a at the exit according to the formula:

a=√(γRT) (a is the speed of sound);

Where: γ is C_{P}/Cᵥ=the ratio of Constant pressure specific heat divided by Constant volume specific heat, i.e γ=1.4 for air;

R is the gas constant (1715 ft-lb/slug ⁰R)

T is the absolute temperature [Rankine]

### EXAMPLES

1. Calculating speed of sound for standard atmosphere at sea level where:

T=59⁰F=519⁰R→a=√(γRT)=√(1.4*1715*519)=√(1,246,119)=1,116.2 FT/SEC

2. Calculating speed of sound for standard atmosphere at altitude of 10,000 FT where:

T=23.36⁰F=483.36⁰R→a=√(γRT)=√(1.4*1715*483.36)=√(1,160,547)=1,077.3 FT/SEC

Increasing the speed of sound at the throat 18 enables the airflow 38 getting more speed while not exceeding Mach=1, which could be a limit for low-pressure exit flow 38. Increasing the exit flow 38 speed means increasing the device thrust. Since the fan 20 efficiency is equal or more than known propeller efficiency and this device also converts the piston engine heat stored in the cooling air 58 and in the exhaust gas 46 into speed, we get more thrust from the same amount of fuel burned by the piston engine. Thus this is a jet engine powered by piston engine, which is more efficient than of a piston engine-propeller combination. Increasing the temperature of the flow 38 also increases exit flow pressure thus enable higher flow speed and consequently higher thrust.

In current piston engines for aircraft, automobiles, motor cycles and other piston engines the generated heat stored in the exhaust gas and the heat due the friction of the moving parts, especially the friction between pistons and cylinders are regarded as a problem that requires additional systems to get rid of. However in this invention, these heats are put into good use and increase engine thrust for the same amount of burnt fuel. This good use of hot gas is a major aspect of the invention.

This jet engine is more efficient than current piston engine combined with propellers since multi wing short blades 62 fan are more efficient than propellers due to increased number of blades that transfer the engine rotating power to the flow more efficiently since the fan blades are shorter than propeller blades and therefore, fans are allowed to rotate at higher RPM without reaching Mach 1 at the blades tip. Thus, fans can reach efficiency of 90% while propellers efficiency is about 80%.

A major advantage of this engine is the intake of atmospheric air 30 and accelerating it through the convergent nozzle 15 thus exploiting its natural stored heat and convert it into kinetic energy according to Bernoulli's law. Current aircraft piston engine equipped with propeller only push air rearward in order to produce thrust. In this invention air 30 is pushed rearward and further accelerated in the convergent nozzle 15, thus exploiting air natural temperature to increase engine thrust, i.e., its efficiency.

Another advantage of this invention is the mixing of hot air or gases with atmospheric air within he nozzle. This mixing of flowing gases is very rapid thus when the gas mixture arrives at the nozzle exit, it has unified temperature. It should be noted that fan may be installed in front of the pod 50 or any where in the nozzle 13 or convergent nozzle 15.

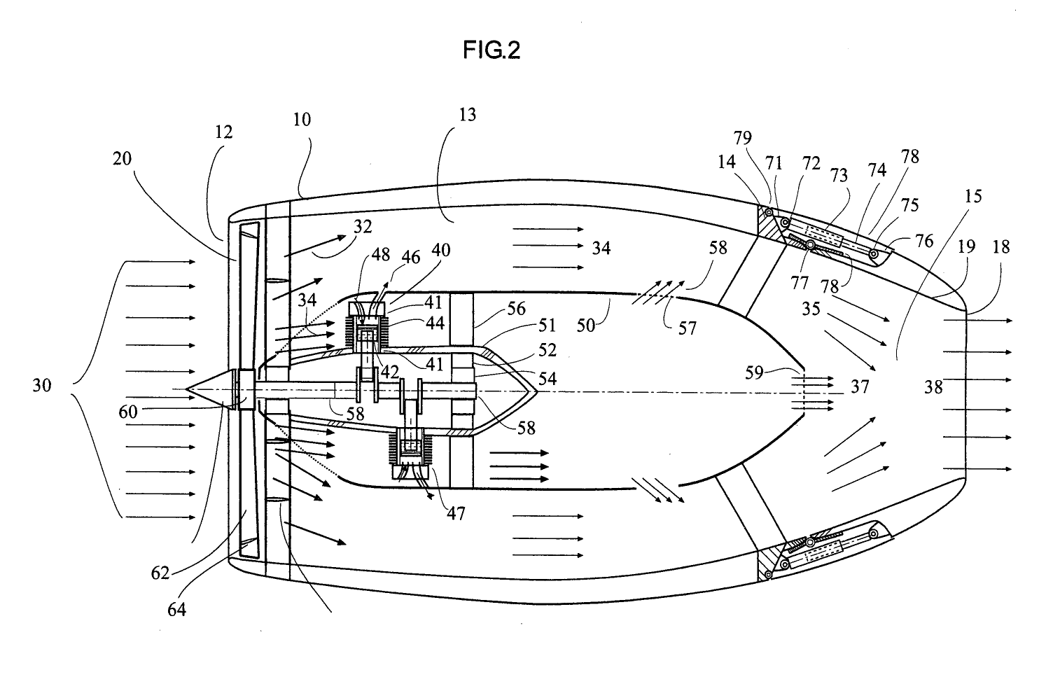

FIG. 2. is a cross section through a pod 10 having similar design to that of FIG. 1. This is a piston jet engine with a variable exit area 18 mechanism. Since this Fig describes the same piston engine 40 and fan 20 design, the explanation and numerals of FIG. 1 applies here. The different part in this design is the rear part of the pod 10, i.e, the moveable multi parts 19, each is rotatable around its own axis 77. A powered actuator 73, each for each part 19, either electrical or hydraulic, push-pull rod 74 attached to hinge 75, which is connected to part 19 through bracket 76. When rod 74 is retracted, hinge 75 is moved toward hinge 72 and part 19 is rotated around axis 77 thus exit area 18 is increased. The importance of this design is to adapt exit area 18 to the mass flow and speed of airflow 38 according to required thrust at various aircraft speed at different flight altitudes and atmospheric conditions, i.e., temperature and pressure.

It should be noted that the exit area could be controlled by a computerized system which take into account, flight speed, flight altitude, air density or by the operator of this engine. It should be noted that fan may be installed in front of the pod 50 or any where in the nozzle 13 or convergent nozzle 15.

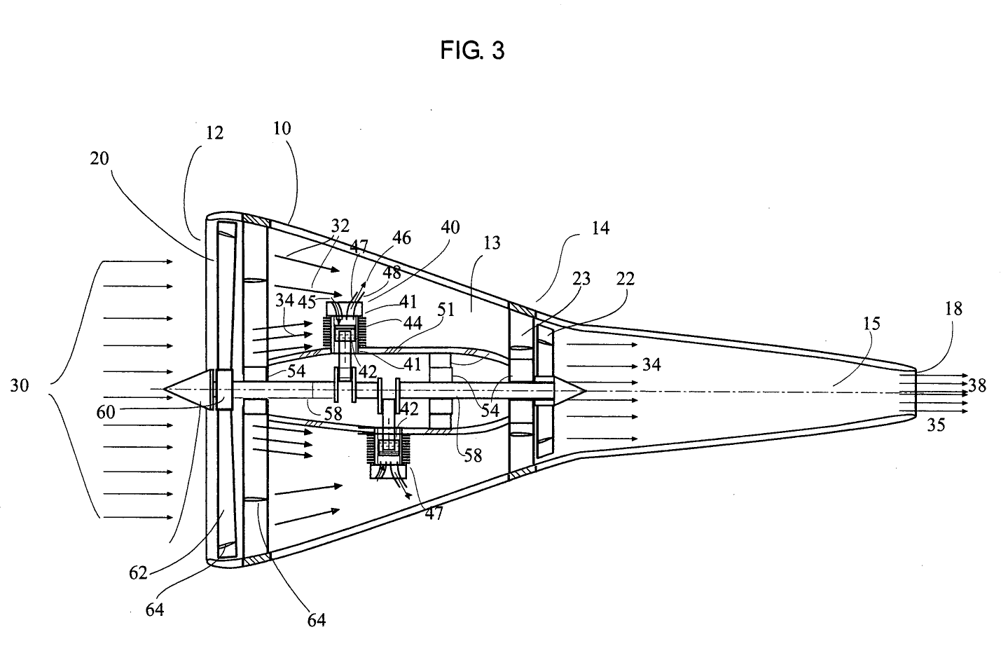

FIG. 3. is a cross section through a pod 10 having similar design to that of. FIG. 1. This is a piston jet engine with optional two axial fans 20, 22, which flows air through the nozzle 13 to cool the piston engine and absorb the heat generated in it by friction between pistons 42 and cylinders 41, 47 and heat stored in the burnt (exhaust) gas 46. The optional fan 22 may be rotated directly by the piston engine main shaft 58 or by optional electric motor 60.

The optional fan 22 could be replaced by a turbine, thus exploiting the flowing air kinetic energy to generate torque to rotate the crankshaft 58. A stator 23 directs the airflow to increase the fan 22 or turbine 22 efficiency.

The same explanation of FIG. 1 applies her. FIG. 3 device is aimed at slower speed than the device in FIG. 1 (for example: motor cycle) and therefore inner pod 50 of FIG. 1 is not included here. The air flow 34 contains all the heat generated by the piston engine and flows toward the exit 18 through a convergent nozzle 15 which accelerates the airflow 38 speed by a factor of about 2 to 10 but not exceeding Mach number of 1 at the exit plane 18. This kinetic energy added to flow 38 is on the expense of the flow temperature according to Bernoulli's law for isentropic compressible flow:

C_{P}T+v²/2=constant=C_{P}T⁰ EQ 3—see Ref. Book P. 153 EQ 20—P. 4 in the appendix.
Where: T⁰ is the stagnation temperature, which is constant in isentropic compressible flow.

C_{P} is the gas constant pressure specific heat , C_{P}]ₐᵢᵣ=6000 ft-lb/slug ⁰R

T is gas absolute temperature (Rankine)

V is gas speed [FT/SEC]

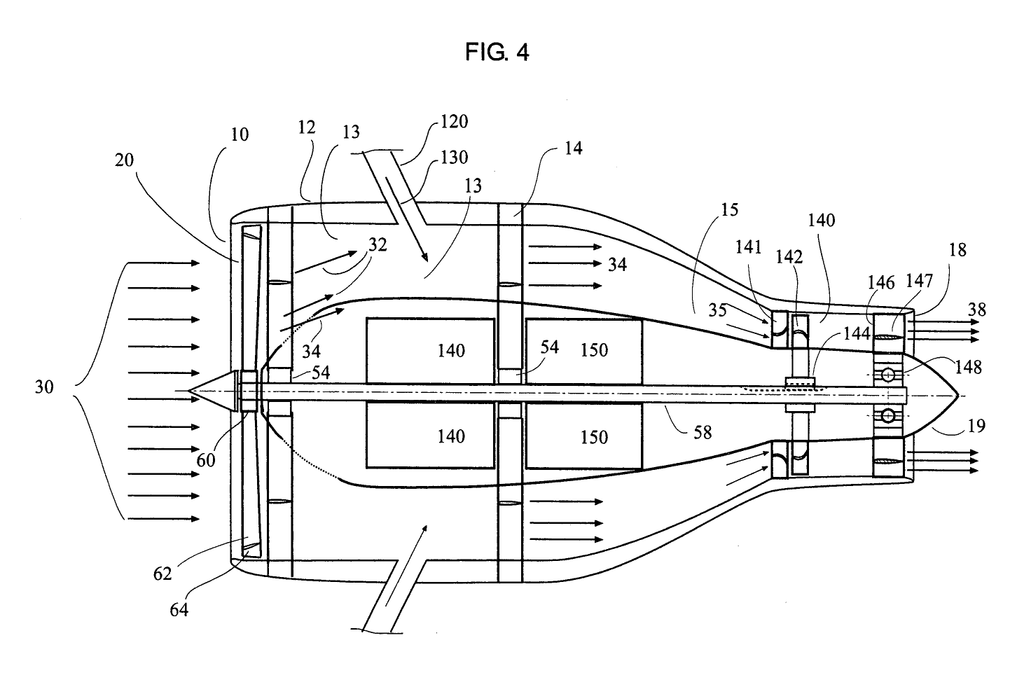

Thus, since the convergent nozzle 15 accelerates the flow, i.e., v in EQ (3) increases, T must decrease. (see FIG. 4 in P. 153 of the Ref book). This mechanism turns the heat generated by the piston engine into kinetic energy and now we have high speed flow 38, which contributes a significant amount of thrust to the vehicle.

It should be noted that fan may be installed in front of the pod 51 or anywhere in the nozzle 13 or convergent nozzle 15.

FIG. 4 is a cross section view through a device, which generates electricity from hot gas. An electrical engine 140 rotates a shaft 58 that rotates fan 20 made of plurality of blades 62. Flow 30 is either atmospheric air or hot air used to cool other system such as electrical generators or alike. Pipe 120 directs hot gases such as produced by internal combustion engines (piston engine) into the device nozzle 13. Sucked atmospheric air 32 is mixed with hot gas 130 and the mixture 34 is flowing toward convergent nozzle 15 which accelerates the gas on the expense of it own temperature- see explanation for FIG. 1, where a turbine 140 is installed. The accelerated gas 35 rotates the turbine rotor 142, which is mounted on shaft 58 and rotates it. Shaft 58 is mounted by bearings 54 and 148. Turbine 140 is preferable axial turbine comprises a stator 141 and rotor 142. Shaft 58 rotates electrical generator 150, which generates electricity. It should be noted that electrical engine 140 and electrical generator 150 may be replaced by one electrical engine 140, which transforms itself into electrical generator when the shaft 58 rotates in a speed slightly higher than the electrical engine 140 nominal speed. For example, if the electrical engine nominal speed is 3000 RPM and the turbine rotor rotates the shaft at 3200 RPM than the electrical engine 140 acts as electrical generator, i.e., generates electricity rather than consume electricity. In such a case fan 20 is designed to rotate at 3200 RPM while the turbine rotor design to rotate at 3200 RPM.

This design could be used in hybrid cars to generate electricity from the car piston engine exhaust gas, which are currently discarded while containing precious thermal energy, which contribute to global warming. Thus this design makes good use for wasted gas produced by about 250 million cars powered by piston engines. It should be noted that the power output of turbine 150 is larger than the power required to drive fan 20 thus net power in the form of electricity is produced and can be stored by electrical battery or driving electrical motors that power car road wheels.

Another use of this device is in using hot gases generated by gas-powered turbo-generators for electricity production. In current design, the turbine burnt gases are discarded while at temperature of 200° Fahrenheit. This is a pure waste and another negative contribution to global warming. It should be noted that fan may be installed in front of the pod 12 or any where in the nozzle 13 or convergent nozzle 15.

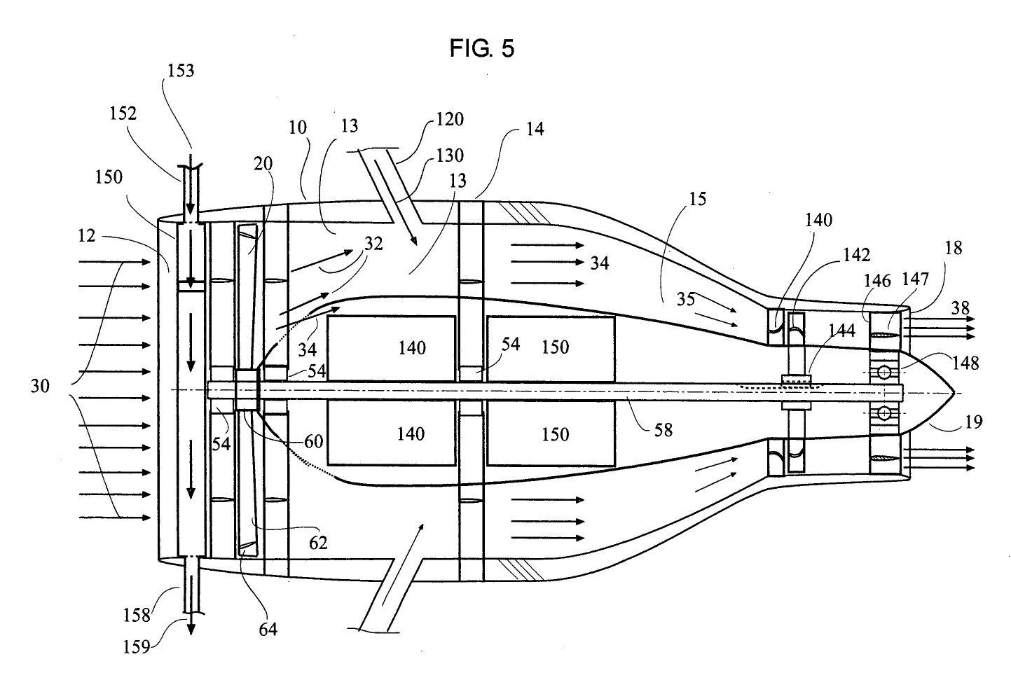

FIG. 5 is a cross section in a device similar to that of FIG. 4. The difference here is the radiator 150 installed at the pod 10 inlet 12. Radiator 150 inlet pipe 152 flows engine hot cooling liquid 153 into the radiator, similar in design to those found in modern cars, i.e., airflow 30 is sucked by fan 20 and flows through the radiator and absorbs its heat. Consequently, flow 32 is hotter than flow 30. Optional pipe 120 flows additional hot gasses 130 into the device nozzle. The rear part of the device, i.e., the convergent nozzle, the turbine and the electrical generator 150 are the same as in FIG. 3. This device purpose is similar to that of FIG. 4. It should be noted that fan may be installed in front of the radiator 150 or any where in the nozzle 13 or convergent nozzle 15.

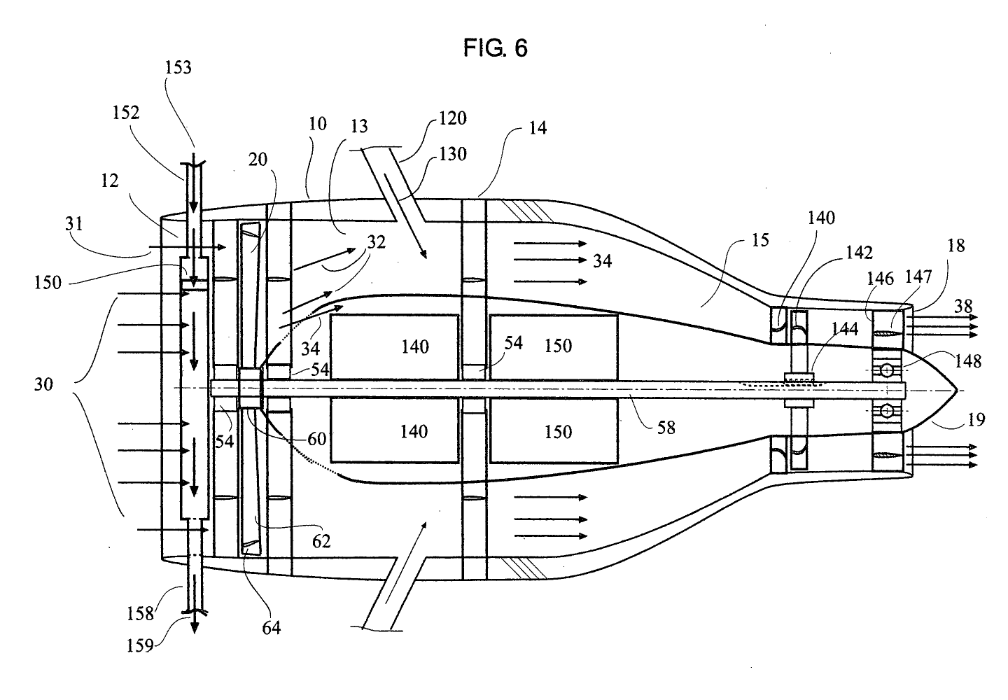

FIG. 6 is a cross section is another version of the device shown in FIG. 5 where the radiator 150 is smaller the device inlet area thus atmospheric air 31 enters the device without flowing through the radiator 50. The advantage of this design is that flow 31 enters the device without the resistance causes by the radiator 150, thus enabling increased mass flow within the device. The power generated by the turbine is a function of the flow 35 speed, mass and temperature. Thus, by increasing flow mass ratio by adding atmospheric air mass, the turbine power output increases. It should be noted that fan may be installed in front of the radiator 150 or any where in the nozzle 13 or convergent nozzle 15.

It will be appreciated that the invention is not limited to what has been described hereinabove merely by way of example. Rather, the invention is limited solely by the claims, which follow.

1. A method of using gas internal energy (thermal energy+kinetic energy) that is a product of cooling parts of system, or internal combustion engine, or exhaust gas which is product of burning fuels of any kind and especially fossil fuel such as: oil, gas, petrol, kerosene, diesel fuel, coal or others by:
a. flowing this gas through a nozzle which at least one part of said nozzle is a convergent nozzle which accelerates gas speed while the gas getting colder according to Bernoulli's law for compressible flow, i.e., the gain of kinetic energy per unit mass ΔV²/2, (V is gas speed) of the flowing gas, is equals to the decrease of gas thermal energy per unit mass: C_{P}*ΔT, where C_{P} is the gas constant pressure specific heat and ΔT is the gas temperature decrease during acceleration inside the convergent nozzle;
b. either flowing the accelerated gas through a turbine that drives electrical generator that generates electricity, said electricity power is about equal to the decrease of flowing gas internal energy second and further ejecting this gas through nozzle exit to generate thrust, or, ejecting the accelerated gas into the atmosphere to create thrust opposite in direction to the gas speed or, combination of flowing the gas through the turbine and creating thrust to push a vehicle in a desired direction.

2. A method according to claim 1 where the hot gas is mixed with atmospheric air flowing together with the hot gas into the convergent nozzle.

3. A method according to claim 1 where the turbine add torque to the engine crankshaft or to the fan driving shaft.

4. A jet engine according to claim 2 comprises:
a. a nozzle having an inlet and at least one part of said nozzle is convergent nozzle and nozzle exit where gas is flowing through nozzle inlet, convergent nozzle and further toward nozzle exit to generate thrust;
b. an internal combustion engine installed near or preferably inside said nozzle and transfer part or all of its generated heat to a flow in said nozzle;
c. a powered fan installed in said nozzle, either powered by said piston engine or by independent electrical motor or by other power source, said fan pushes gas to flow inside said nozzle.
d. An optional turbine installed in said nozzle and converts some of the gas kinetic energy into mechanical energy.

5. A jet engine according to claim 4 having a variable exit area.

6. A jet according to claim 5 where the exit area is controlled either by a computerized system or directly by the operator of this engine.

7. A jet according to claim 4 where said turbine drives electrical generator or ads torque to said internal combustion engine or to said fan driving shaft.

8. A device according to claim 1 for generating electricity comprises of:
a. a nozzle having an inlet convergent nozzle and exit where hot gas flows from inlet to exit;
b. an electrical engine installed near or preferably inside said nozzle and transfer part or all of its generated heat to a flow in said nozzle;
c. a fan installed in said nozzle, said fan is driven by electrical engine and sucks hot gas which is a product of burning process and flows it into said nozzle.
d. a convergent nozzle, which is part of said nozzle, said convergent nozzle accelerates the flow toward a nozzle throat;
e. a turbine installed near or at said throat is driven by the flow accelerated in the convergent nozzle, said turbine drives electrical generator.

9. A device according to claim 8 where atmospheric airflow is added to hot gas flow.

10. A device according to claim 8 where a cooling radiator is installed in said nozzle so that atmospheric air flows through this radiator and absorbs heat from said radiator said airflow flows through said nozzle.

11. A device according to claim 10 where cooling radiator is installed in said nozzle so that some of atmospheric air flows through this radiator and another part of atmospheric air bypass this radiator and flows into the nozzle.
